(19) United States
(12) Patent Application Publication
(10) Pub. No.: US 2010/0302398 A1
(43) Pub. Date: Dec. 2, 2010

(54) Digital camera dust error photographed image correction

(75) Inventors: Young-seok An, Suwon-si (KR); Hong-ju Kim, Changwon-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Digital Imaging Co., Ltd., Suwon-si (KR)

(21) Appl. No.: 12/660,623

(22) Filed: Mar. 2, 2010

(30) Foreign Application Priority Data
Mar. 3, 2009 (KR) 10-2009-0018119

(51) Int. Cl. H04N 5/228

(52) U.S. Cl. 348/222.1; 348/E05.031

(57) ABSTRACT

Provided are an apparatus of and method for correcting dust spot position in which a position of a dust spot is detected from an image and corrected in a digital image processing apparatus. The dust spot position correcting apparatus of the digital image processing apparatus includes: a dust sensor sensing dust attached on an imaging device that captures an image; and a digital signal processing unit correcting the sensed dust spot with a color value of the surroundings of a position of the dust spot.

### CROSS-REFERENCE TO RELATED PATENT APPLICATION

This application claims the benefit of Korean Patent Application No. 10-2009-0018119, filed on Mar. 3, 2009, in the Korean Intellectual Property Office, the disclosure of which is incorporated herein in its entirety by reference.

### BACKGROUND

The present invention relates to an apparatus of and method for digital image processing, and more particularly, to an apparatus of and method for correcting a position of a dust spot, in which dust spot on an image is detected and corrected.

In a digital image processing apparatus capturing an image, dust attached to a lens or an image sensor or dust between a subject and the digital image processing apparatus may affect the quality of the captured image.

### SUMMARY

The present invention provides an apparatus and method of correcting a position of a dust spot in a digital image processing apparatus in which a position of dust is detected and corrected, thereby obtaining a clean image.

According to an aspect of the present invention, there is provided a dust spot position correcting apparatus of a digital image processing apparatus, the dust spot correcting apparatus comprising: a dust sensor that senses dust attached on an imaging device that captures an image; and a digital signal processing unit that corrects a position a spot having sensed dust with a color value of surroundings of the position of the dust.

The dust sensor may be a photodetector that senses light that is incident on the imaging device and is diffused by a dust particle.

The digital signal processing unit may comprise: a dust position calculation unit that calculates the position of a dust spot sensed by the dust sensor; an average color value calculation unit that calculates an average color value of the surroundings of the position of the dust spot; and a correction unit that corrects a color value of the position of the dust spot with the calculated average color value.

The dust correcting apparatus may further comprise a memory that stores the calculated position of the dust spot and outputs the stored position of the dust spot to the correction unit.

According to another aspect of the present invention, there is provided a dust correcting apparatus of a digital image processing apparatus that recognizes, when noise is generated at a position of an image or at the same position on at least two Images, the noise as a dust spot, and corrects a color value of the position of the dust spot with a color value of surroundings of the position of the dust spot.

The images may be thumbnail images, consecutively photographed images, or arbitrarily selected images.

The digital signal processing unit may comprise: a comparing unit that compares the images to determine whether noise is generated at the same position on the images; a dust position calculation unit that recognizes, when noise is generated after the comparing, the noise as a dust spot to calculate the position of the dust spot; an average color value calculation unit that calculates an average color value of the surroundings of the position of the dust spot; and a correction unit that corrects a color value of the position of the dust spot with the calculated average color value.

The dust correcting apparatus may further comprise a memory that stores the calculated position of the dust spot and output the position of the dust spot to the correction unit.

According to another aspect of the present invention, there is provided a method of correcting dust spot position in a digital image processing apparatus, the method comprising: (a) sensing dust attached on an imaging device that captures an image, using a dust sensor; and (b) correcting a color value of the position of the sensed dust spot with a color value of the surroundings of the position of the dust spot.

In (a), whether a dust spot is present may be determined by receiving light that is incident on the imaging device and is diffused by a dust particle.

(b) may comprise: (b-1) calculating the position of the sensed dust; (b-2) calculating an average color value of the surroundings of the position of the dust spot; and (b-3) correcting a color value of the position of the dust spot with the average color value.

The method may further comprise: (b-4) determining whether the dust spot is removed from the image after the correcting; (b-5) repeating (b-1) through (b-3) if the dust spot is not removed; and (b-6) storing the calculated position of the dust spot when the dust spot is removed from the image after the correcting.

When the stored position of the dust spot and the calculated position of the dust spot are different, the position of the dust stored may be updated and stored.

According to another aspect of the present invention, there is provided a method of correcting a position of dust spot, which is an operating method of a digital image processing apparatus, the method comprising: (a) recognizing, when noise is generated at the same position on at least two images, the noise as a dust spot; and (b) correcting a color value of a position of the dust spot with a color value of surroundings of the position of the dust spot.

The images in (a) may be thumbnail images, consecutively photographed images, or arbitrarily selected images.

(a) may comprise: (a-1) comparing the images to determine whether noise is generated at the same position on the images; and (a-2) recognizing, when noise is generated at the same position on the images after the determining, the noise as a dust spot.

(b) may comprise: (b-1) calculating the position of the sensed dust spot; (b-2) calculating an average color value of the surroundings of the position of the dust spot; and (b-3) correcting a color value of the position of the dust spot with the average color value.

The method may further comprise: (b-4) determining whether the dust spot is removed after the correcting; (b-5) repeating (b-1) through (b-3) if the dust spot is not removed; and (b-6) storing, when the dust spot is removed from the image after the correcting, the calculated position of the dust spot.

When the stored position of the dust spot and the calculated position spot of the dust are different, the position of the dust spot stored may be updated and stored.

Accordingly, a position of a dust spot can be detected from an image and corrected, thereby obtaining a clean image.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a digital image processing apparatus having a dust spot correcting apparatus according to an embodiment of the present invention;

FIG. 2 is a block diagram of a digital signal processing unit and nearby units in the digital image processing apparatus of FIG. 1, according to an embodiment of the present invention;

FIG. 3 is a schematic pictorial view for explaining dust position correction' using the units of FIG. 2;

FIG. 4 is a block diagram of a digital signal processing unit of FIG. 1, according to another embodiment of the present invention;

FIG. 5 is a schematic pictorial view for explaining dust position correction using the units of FIG. 4;

FIG. 6 is a flowchart illustrating a method of correcting a position of dust spot in the digital image processing apparatus of FIG. 1, according to an embodiment of the present invention; and

FIG. 7 is a flowchart illustrating a method of correcting a position of dust spot in the digital image processing apparatus of FIG. 1, according to another embodiment of the present invention.

### DETAILED DESCRIPTION OF THE EMBODIMENTS

The present invention will now be described more fully with reference to the accompanying drawings, in which exemplary embodiments of the invention are shown.

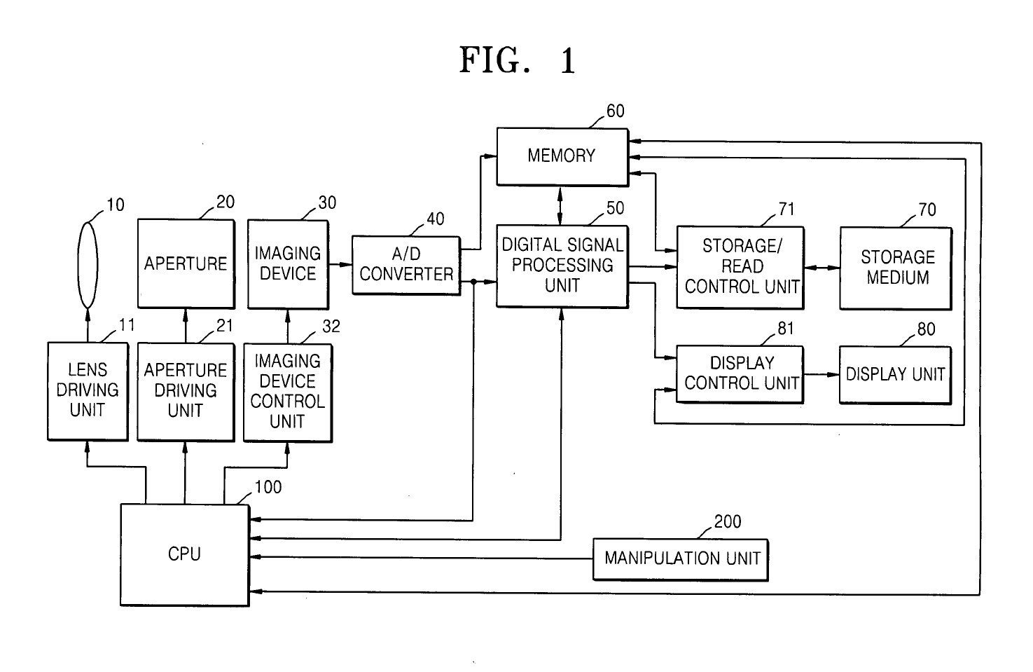

FIG. 1 illustrates a digital image processing apparatus having a dust spot correcting apparatus according to an embodiment of the present invention. In FIG. 1, the digital image processing apparatus is illustrated as a digital photographing apparatus. However, the digital image processing apparatus is not limited to a digital photographing apparatus, and the present invention may also be applied to personal digital assistants (PDAs), portable multimedia players (PMPs), and so forth, of which include a white balance adjusting function. This applies also to embodiments and modified examples thereof that will be described below.

Overall operations of the digital image processing apparatus are controlled by a central processing unit (CPU) 100. The digital photographing apparatus includes a manipulation unit 200 including keys for generating an electrical signal transmitted by a user. The electrical signal transmitted from the manipulation unit 200 is transmitted to the CPU 100 and then the CPU 100 controls the digital image processing apparatus according to the electrical signal.

In a photographing mode, an electrical signal transmitted by the user is applied to the CPU 100, and the CPU 100 detects the electrical signal and may control a lens driving unit 11, an aperture driving unit 21, and an imaging device control unit 32, and accordingly, the position of a lens unit 10, the aperture size of an aperture 20, and the sensitivity of an imaging device 30 may be controlled. The imaging device 30 generates data from incident light on the image device 30, and an analog/digital (A/D) converter 40 converts analog data output by the imaging device 30 into digital data. The imaging device 30 may not need the A/D converter 40 according to the characteristics thereof.

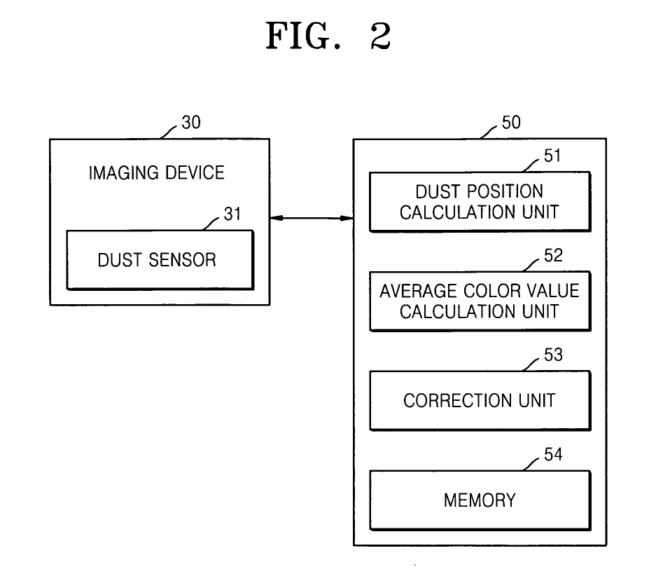

Data generated by the imaging device 30 may be input to a digital signal processing unit 50 via a memory 60, or directly to the digital signal processing unit 50 without passing through the memory 60, or to the CPU 100, according to necessity. Examples of the memory 60 include a read only memory (ROM) or a random access memory (RAM). The digital signal processing unit 50 may perform digital signal processing such as gamma correction or white balance adjustment. Also, the digital signal processing unit 50 may include a dust position calculation unit 51, an average color value calculation unit 52, a correction unit 53, and a memory 54 as illustrated in FIG. 2, or may include an image comparing unit 55, a dust position calculation unit 56, an average color value calculation unit 57, a correction unit 58, and a memory 59 as illustrated in FIG. 4. These elements may also be modified in various manners; for example, the elements need not be included in the digital signal processing unit 50 but can be separate elements from the digital signal processing unit 50.

Data output by the digital signal processing unit 50 may be transmitted to a display control unit 81 via the memory 60 or directly thereto. The display control unit 81 controls a display unit 80 to display the data as an image on the display unit 80. According to the current embodiment of the present invention, the display unit 80 may be a touch screen. Data output by the digital signal processing unit 50 may be input to a storage/read control unit 71 via the memory 60 or directly thereto, and the storage/read control unit 71 may store image data into a storage medium 70 according to a signal sent from the user, or automatically. The storage/read control unit 71 may read data from an image file stored in the storage medium 70 and may input the data to the display control unit 81 via the memory 60 or via other path, thereby displaying an image on the display unit 80. The storage medium 70 may be detachable or permanently mounted in the digital image processing apparatus.

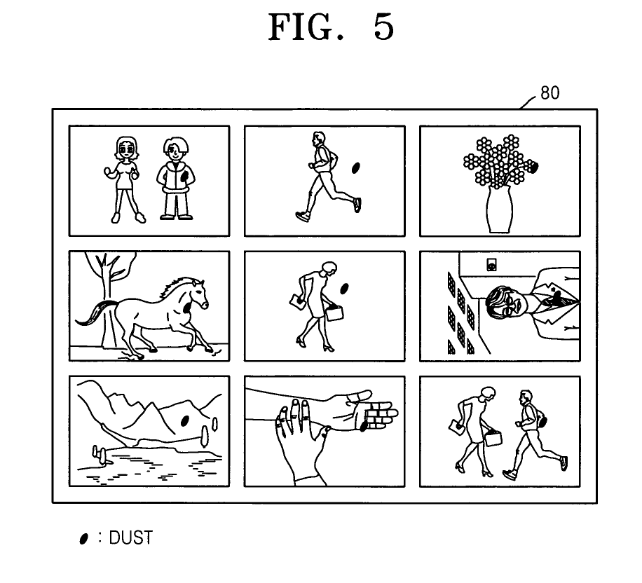

The function of the digital signal processing unit 50 according to the current embodiment of the present invention will be described in detail with reference to FIGS. 2 and 5.

FIG. 2 is a detailed block diagram of the digital signal processing unit 50 of FIG. 1 and nearby elements thereto according to an embodiment of the present invention. The digital signal processing unit 50 includes a dust position calculation unit 51, an average color value calculation unit 52, a correction unit 53, and a memory 54. Also, a dust sensor 31 is included in the imaging device 30 in order to sense dust.

The dust sensor 31 senses dust attached on the imaging device 30, which captures an image. The dust sensor 31 may be a photodetector (not shown) that senses light that is incident on the imaging device 30 and is diffused by a dust particle. The dust sensor 31 may include an optical transmitting unit (not shown) and an optical receiving unit (not shown). The optical transmitting unit emits light toward dust present in the imaging device 30, and the optical receiving unit receives light reflected by the dust.

The digital signal processing unit 50 corrects a position of a spot having dust sensed by the dust sensor 31 with a color value corresponding to color values surrounding the dust spot. To this end, the digital signal processing unit 50 includes the dust position calculation unit 51, the average color value calculation unit 52, and the correction unit 53.

The dust position calculation unit 51 calculates the position of the dust spot sensed by the dust sensor 31. The dust position calculation unit 51 divides an image into a predetermined number of blocks. If a signal level of a block, for example, an average color value, is remarkably lower than other blocks, the dust position calculation unit 51 determines that a dust spot is present in the block and calculates the position of the block. Furthermore, the dust position calculation unit 51 may calculate the position of a dust spot regarding a pixel instead of a block. If a signal level of a pixel is significantly lower than signal levels of other pixels, the dust position calculation unit 51 may determine that a dust spot is present in the pixel and may calculate the position of the dust spot.

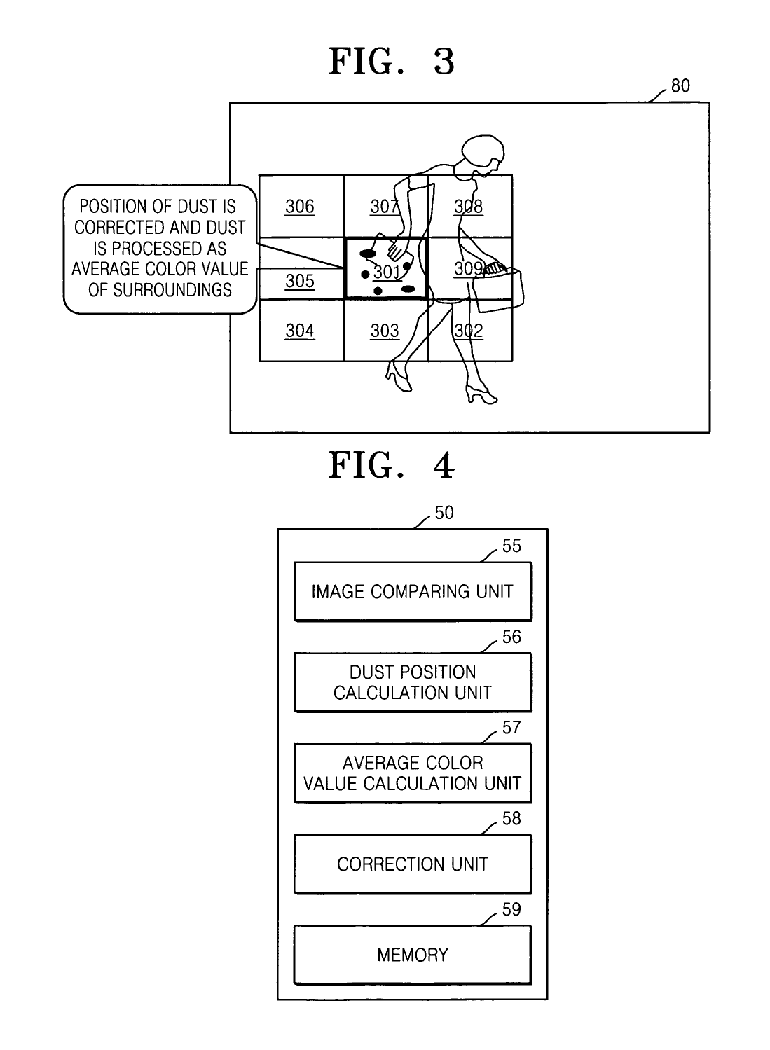

The average color value calculation unit 52 calculates an average color value for a block including a dust spot from other blocks. In FIG. 3, a block 301 including dust spots is illustrated. The average color value calculation unit 52 calculates an average color value of blocks 302 through 309, disregarding the block 301 including dust.

The correction unit 53 corrects a color value of the block 301 where a dust spot is present with the average color value calculated by the average color value calculation unit 52. By correcting the block 301, which includes dust spots and has a significantly low signal level, with the average color value of the other blocks 302 through 309, a clean image may be obtained.

The memory 54 may store the position of a dust spot calculated by the dust position calculation unit 51 and thus may regard the position of the dust spot when capturing an image. Also, the dust position calculation unit 51 compares the position of a dust spot stored in the memory 54 and the position of a dust spot that is calculated most recently, and if the positions are different, the dust position calculation unit 51 may update the position of the dust spot stored in the memory 54.

FIG. 4 is a detailed block diagram of the digital signal processing unit 50 according to another embodiment of the present invention. In the digital signal processing unit 50 of the embodiment of FIG. 2, a dust spot is sensed by the dust sensor 31, but the digital signal processing unit 50 of the embodiment of FIG. 4 operates without a dust sensor.

When noise is generated at the same position on at least two images, the digital signal processing unit 50 of the embodiment of FIG. 4 recognizes the noise as a dust spot and corrects the color value of the position of the dust spot with a color value corresponding to color values surrounding the position of the dust spot.

To this end, the digital signal processing unit 50 includes an image comparing unit 55, a dust position calculation unit 56, an average color value calculation unit 57, a correction unit 58, and a memory 59.

The image comparing unit 55 determines whether noise is generated at the same position on at least two images by comparing the images. In the current embodiment of the present invention, the images may be thumbnail images, consecutively photographed images, or at least two images selected arbitrarily. In FIG. 5, thumbnail images on which noise is generated at the same position are illustrated.

After comparing the images, when noise is detected at the same position on the images, the dust position calculation unit 56 recognizes the noise as a dust spot and calculates the position of the dust spot. The dust position calculation unit 56 divides an image into a predetermined number of blocks. If a signal level (e.g., average color value) of a block is significantly lower than signal levels of other blocks, the dust position calculation unit 56 determines that a dust spot is present in the block and calculates the position of the dust spot. Furthermore, the dust position calculation unit 56 may calculate the position of a dust spot regarding a pixel instead of a block. When a signal level of a pixel is significantly lower than signal levels of nearby pixels, the dust position calculation unit 56 determines that a dust spot is present in the pixel and calculates the position of the dust spot.

The average color value calculation unit 57 calculates an average color value of nearby blocks, disregarding the block including a dust spot. The calculation of the average color value is described with reference to FIG. 3 and thus descriptions will not be repeated.

The correction unit 58 corrects a color value of a block including a dust spot with the average color value calculated by the average color value unit 57. The correction unit 58 corrects blocks that include a dust spot and have a significantly low signal level, with the average color value of nearby blocks, thereby obtaining a clean image.

The memory 59 may store the position of a dust spot calculated by the dust position calculation unit 56 and may apply the same when capturing an image. Also, the dust position calculation unit 56 compares the position of the dust spot stored in the memory 59 and the position of a dust spot that is calculated most recently, and if the positions are different, the dust position calculation unit 56 updates the position of the dust spot stored in the memory 59.

Hereinafter, a method of correcting dust spot position in a digital image processing apparatus according to an embodiment of the present invention will be described in detail. The method of correcting dust spot position may be performed in the digital image processing apparatus illustrated as in FIG. 1, and main algorithms of the method may be performed in the digital signal processing unit 50 with the help of nearby components in the digital signal processing apparatus.

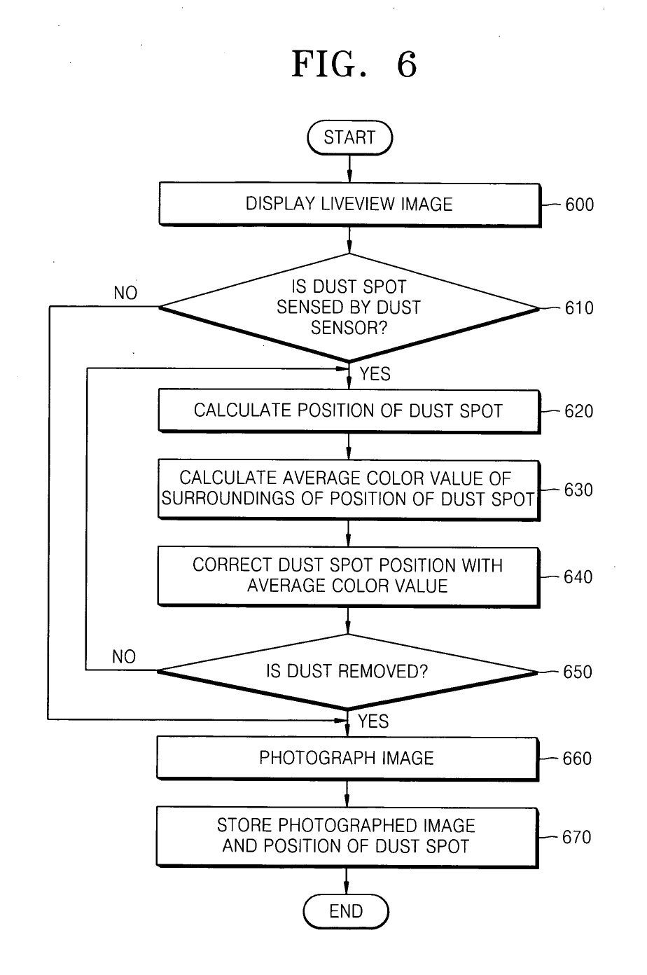

First, a method of correcting dust spot position in the digital image processing apparatus according to an embodiment of the present invention will be described with reference to FIG. 6.

In operation 600, when power is supplied to the digital image processing apparatus, the digital signal processing unit 50 may display a liveview image on the display unit 80.

Next, in operation 610, the digital signal processing unit 50 determines whether dust is sensed by the dust sensor 31. The dust sensor 31 senses dust attached on the imaging device 30, which captures an image, by sensing light that is incident on the imaging device 30 and is diffused by a dust particle. An optical signal sensed by the dust sensor 31 is output to the digital signal processing unit 50, and the digital signal processing unit 50 receives the optical signal to sense dust.

When a dust spot is detected by the dust sensor 31, the digital signal processing unit 50 calculates a position of the dust spot in operation 620. The digital signal processing unit 50 divides an image into a predetermined number of blocks. If a signal level of a block, for example, an average color value, is significantly lower than signal levels of other surrounding blocks, the digital signal processing unit 50 determines that a dust spot is present in the block and calculates the position of the dust spot. Also, if a signal level of a pixel is significantly lower than signal levels of other surrounding pixels, the digital signal processing unit 50 determines that a dust spot is present in the pixel and calculates the position of the dust spot.

After the position of the dust spot is calculated, the digital signal processing unit 50 calculates an average color value of nearby blocks, disregarding the block including a dust spot, in operation 630. In FIG. 3, the block 301 including dust spots is illustrated. The digital signal processing unit 50 calculates an average color value of the blocks 302 through 309, disregarding the block 301 including dust spots.

After the average color value is calculated, the digital signal processing unit 50 corrects a color value of the block 301 including dust spots, with the calculated average color value in operation 640. Thus, by correcting the block that includes dust and has a significantly lower signal level, with the average color value of nearby blocks, a clean image can be obtained.

In operation 650, after correcting the dust spot position, the digital signal processing unit 50 determines whether the dust spot is removed from the liveview image. The digital signal processing unit 50 determines whether the dust spot is removed by measuring the signal level of a block including a dust spot. If a dust spot is not removed, the digital signal processing unit 50 repeats the operations 620 through 640.

After the dust is removed, in operation 660, the digital signal processing unit 50 captures an image by receiving a shutter button input transmitted from the user. The photographed image is stored in the storage medium 70 and the position of the dust is stored in the digital signal processing unit 50 in operation 670. The position of a block including a dust stored in the digital signal processing unit 50 is always regarded when capturing an image. Also, the digital signal processing unit 50 compares the stored position of the dust and the position of a dust spot that is calculated most recently, and if the positions are different, the digital signal processing unit 50 may update the position of the dust spot stored in the digital signal processing unit 50.

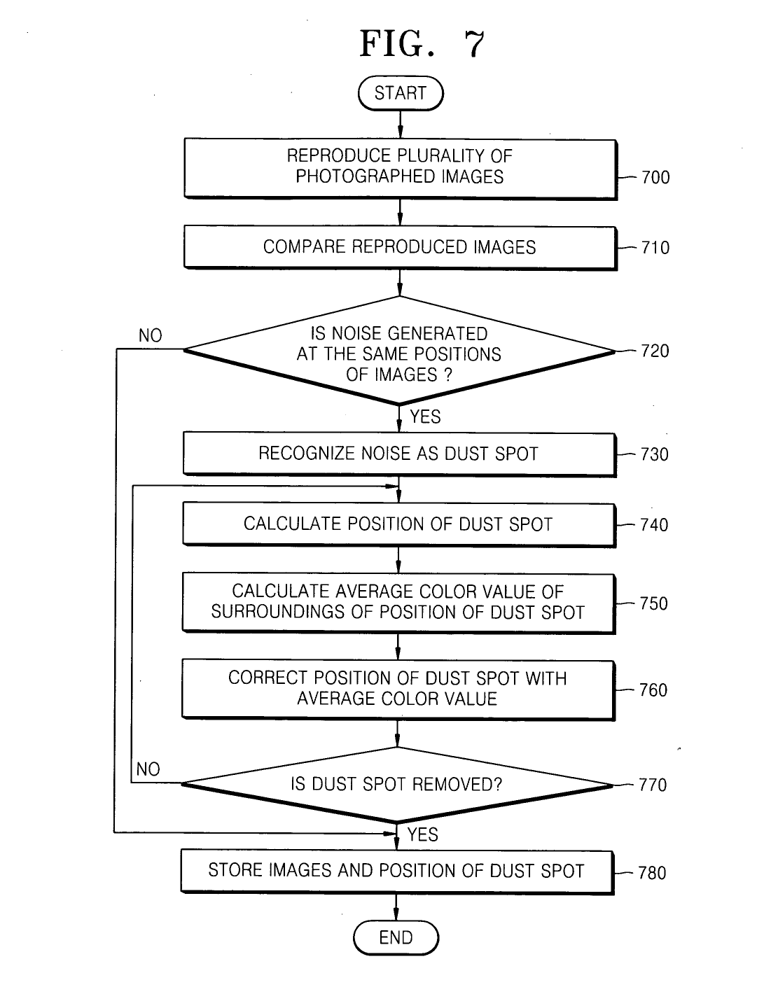

Next, a method of correcting a dust spot position in the digital image processing apparatus according to another embodiment of the present invention will be described with reference to FIG. 7.

In operation 700, power is supplied to the digital image processing apparatus and an image play signal is transmitted from the user to the digital signal processing unit 50, thereby reproducing a plurality of images on the display unit 80. In the current embodiment, the images may be thumbnail images, consecutively photographed images, or at least two arbitrarily selected images. In FIG. 5, thumbnail images are displayed.

When images are reproduced, the digital signal processing unit 50 compares the images in operation 710. In operation 720, whether noise is generated at the same position on the images is determined. The digital signal processing unit 50 divides the images into a predetermined number of blocks, and if a signal level of a block, for example, an average color value, is significantly lower than signal levels of nearby blocks, the digital signal processing unit 50 determines that noise is present in the block.

In operation 730, when noise is generated at the same position on the images, the digital signal processing unit 50 recognizes the noise as a dust spot.

Next, in operation 740, the digital signal processing unit 50 calculates the position of a dust spot. In order to recognize the dust spot, the position of a block including the dust may be calculated by using the blocks.

After the position of the dust spot is calculated, the digital signal processing unit 50 calculates an average color value of nearby blocks, disregarding the block including the dust spot, in operation 750. The calculation of the average color value is described with reference to FIG. 3 and thus will not be described again.

After the calculation of the average color value is finished, the digital signal processing unit 50 corrects a color value of the block including the dust spot with the calculated average color value in operation 760. By correcting the block that includes the dust and has a significantly low signal level with the average color value of the nearby blocks, a clean image can be obtained.

After correcting the dust spot position, in operation 770, the digital signal processing unit 50 determines whether the dust spot is removed from the image. The digital signal processing unit 50 measures the signal level of the block including the dust spot. If the dust spot is not removed, the digital signal processing unit 50 repeats the operations 740 through 760.

When the dust spot is removed, in operation 780, the digital signal processing unit 50 stores the corrected image in the storage medium 70 according to selection by the user, and the position of the dust spot is stored in the digital signal processing unit 50. The position of the block including the dust spot stored in the digital signal processing unit 50 is always applied when capturing an image. Also, the digital signal processing unit 50 compares the position of the dust spot stored in the digital signal processing unit 50 and the position of a dust spot that is calculated most recently, and when the positions are different, the digital signal processing unit 50 may update the position of the dust spot stored in the digital signal processing unit 50.

Various functions can be implemented using software modules, and these software modules may be stored as program instructions or computer readable codes executable on the processor on a computer-readable media such as read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. This media can be read by the computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the preferred embodiments illustrated in the drawings, and specific language has been used to describe these embodiments. However, no limitation of the scope of the invention is intended by this specific language, and the invention should be construed to encompass all embodiments that would normally occur to one of ordinary skill in the art.

The present invention may be described in terms of functional block components and various processing steps. Such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, where the elements of the present invention are implemented using software programming or software elements the invention may be implemented with any programming or scripting language such as C, C++, Java, assembler, or the like, with the various algorithms being implemented with any combination of data structures, objects, processes, routines or other programming elements. Furthermore, the present invention could employ any number of conventional techniques for electronics configuration, signal processing and/or control, data processing and the like. The words “mechanism” and “element” are used broadly and are not limited to mechanical or physical embodiments, but can include software routines in conjunction with processors, etc.

The particular implementations shown and described herein are illustrative examples of the invention and are not intended to otherwise limit the scope of the invention in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the invention unless the element is specifically described as “essential” or “critical”.

The use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed.

Numerous modifications and adaptations will be readily apparent to those skilled in this art without departing from the spirit and scope of the present invention.

What is claimed is:

1. A dust spot position correcting apparatus of a digital image processing apparatus, the dust spot correcting apparatus comprising:
a dust sensor that senses dust attached on an imaging device that captures an image; and
a digital signal processing unit that corrects a position of a spot having sensed dust with a color value of surroundings of the position of the dust.

2. The dust spot position correcting apparatus of claim 1, wherein the dust sensor is a photodetector that senses light that is incident on the imaging device and is diffused by a dust particle.

3. The dust spot position correcting apparatus of claim 2, wherein the digital signal processing unit comprises:
a dust position calculation unit that calculates the position of a dust spot sensed by the dust sensor;
an average color value calculation unit that calculates an average color value of the surroundings of the position of the dust spot; and
a correction unit that corrects a color value of the position of the dust spot with the calculated average color value.

4. The dust spot position correcting apparatus of claim 3, further comprising a memory that stores the calculated position of the dust spot and outputs the stored position of the dust spot to the correction unit.

5. A dust spot position correcting apparatus of a digital image processing apparatus that recognizes, when noise is generated at a position of an image or at the same position on at least two images, the noise as a dust spot, and corrects a color value of the position of the dust spot with a color value of surroundings of the position of the dust spot.

6. The dust spot position correcting apparatus of claim 5, wherein the images are thumbnail images, consecutively photographed images, or arbitrarily selected images.

7. The dust spot position correcting apparatus of claim 6, wherein the digital signal processing unit comprises:
a comparing unit that compares the images to determine whether noise is generated at the same position on the images;
a dust position calculation unit that recognizes, when noise is generated after the comparing, the noise as a dust spot to calculate the position of the dust spot;
an average color value calculation unit that calculates an average color value of the surroundings of the position of the dust spot; and
a correction unit that corrects a color value of the position of the dust spot with the calculated average color value.

8. The dust spot position correcting apparatus of claim 7, further comprising a memory that stores the calculated position of the dust spot and outputs the position of the dust spot to the correction unit.

9. A method of correcting dust spot position in a digital image processing apparatus, the method comprising:
(a) sensing dust attached on an imaging device that captures an image, using a dust sensor; and
(b) correcting a color value of the position of the sensed dust spot with a color value of the surroundings of the position of the dust spot.

10. The method of claim 9, wherein in (a), whether a dust spot is present is determined by receiving light that is incident on the imaging device and is diffused by a dust particle.

11. The method of claim 10, where (b) comprises:
(b-1) calculating the position of the sensed dust;
(b-2) calculating an average color value of the surroundings of the position of the dust spot; and
(b-3) correcting a color value of the position of the dust spot with the average color value.

12. The method of claim 11, further comprising:
(b-4) determining whether the dust spot is removed from the image after the correcting;
(b-5) repeating (b-1) through (b-3) if the dust spot is not removed; and
(b-6) storing the calculated position of the dust spot when the dust spot is removed from the image after the correcting.

13. The method of claim 12, wherein when the stored position of the dust spot and the calculated position of the dust spot are different, the position of the dust stored is updated and stored.

14. A method of correcting a position of dust spot, which is an operating method of a digital image processing apparatus, the method comprising:
(a) recognizing, when noise is generated at the same position on at least two images, the noise as a dust spot; and
(b) correcting a color value of a position of the dust spot with a color value of surroundings of the position of the dust spot.

15. The method of claim 14, wherein the images in (a) are thumbnail images, consecutively photographed images, or arbitrarily selected images.

16. The method of claim 15, wherein (a) comprises:
(a-1) comparing the images to determine whether noise is generated at the same position on the images; and
(a-2) recognizing, when noise is generated at the same position on the images after the determining, the noise as a dust spot.

17. The method of claim 16, wherein (b) comprises:
(b-1) calculating the position of the sensed dust spot;
(b-2) calculating an average color value of the surroundings of the position of the dust spot; and
(b-3) correcting a color value of the position of the dust spot with the average color value.

18. The method of claim 17, further comprising:
(b-4) determining whether the dust spot is removed after the correcting;
(b-5) repeating (b-1) through (b-3) if the dust spot is not removed; and
(b-6) storing, when the dust spot is removed from the image after the correcting, the calculated position of the dust spot.

19. The method of claim 18, wherein when the stored position of the dust spot and the calculated position spot of the dust are different, the position of the dust spot stored is updated and stored.
